(19) United States
(12) Patent Application Publication
(10) Pub. No.: US 2006/0279568 A1
(43) Pub. Date: Dec. 14, 2006

(54) Image display method and computer readable medium for image display

(75) Inventor: Kazuhiko Matsumoto, Minato-ku (JP)

Correspondence Address: PEARNE & GORDON LLP, 1801 EAST 9TH STREET, SUITE 1200, CLEVELAND, OH, 44114-3108, US

(73) Assignee: Ziosoft, Inc., Tokyo (JP)

(21) Appl. No.: 11/385,059

(22) Filed: Mar. 21, 2006

(30) Foreign Application Priority Data
Jun. 14, 2005 (JP) 2005-174174

(51) Int. Cl. G06T 15/00

(52) U.S. Cl. 345/419

(57) ABSTRACT

A three-dimensional image as a tubular tissue (colon) is divided longitudinally along a center line (path) is generated, and divided pieces are displayed in association with each other. When the number of dividing planes is one, the dividing plane and the divided pieces may be simply synthesized. However, when the number of dividing planes is two or more, one dividing plane is covered with another. Thus, dividing planes corresponding to each of the divided pieces are generated, and a portion of each dividing plane not touching the divided piece is deleted. Accordingly, all divided pieces are displayed, so that the inner wall can be observed for 360 degrees. Unlike the exfoliated image, the image does not contain distortion and the positional relationship is also easy to understand. When dividing with two or more dividing planes, a plurality of dividing planes contained in one divided piece can be observed simultaneously.

This application claims foreign priority based on Japanese Patent application No. 2005-174174, filed Jun. 14, 2005, the content of which is incorporated herein by reference in its entirety.

### BACKGROUND OF THE INVENTION

1. Field of the Invention

This invention relates to an image display method and a computer readable medium for image display, for visualizing a tubular tissue.

2. Description of the Related Art

A revolution is brought about in the medical field with the advent of CT (Computed Tomography) and MRI (Magnetic Resonance Imaging) making it possible to directly observe an internal structure of a human body, by the progress in the image processing technology using a computer. Medical diagnosis using tomographic images of a living body is widely conducted. Further, in recent years, as a technology for visualizing a complicated three-dimensional structure of the inside of a human body which is hard to understand simply from the tomographic images of the human body, for example, volume rendering has been used for medical diagnosis. In volume rendering, an image of the three-dimensional structure is directly rendered from three-dimensional digital data of an object provided by CT.

In volume rendering, there are methods such as Ray casting, MIP (Maximum Intensity Projection), MinIP (Minimum Intensity Projection), MPR (Multi Planar Reconstruction), CPR (Curved Planar Reconstruction). Further, a 2D (two-dimensional) slice image, etc., is generally used as two-dimensional image processing.

A minute unit area forming a constituent unit of a three dimensional area of an object is called a voxel, and an intrinsic data of the voxel representing the characteristic such as a density value is called a voxel value. The entire object is represented by the voxel data which is the three dimensional array of the voxel values. Usually, two dimensional tomographic image data obtained by a CT scanner or other image acquiring system is layered along a direction perpendicular to a tomographic face of the object, and interpolated, as required, whereby the voxel data of the three dimensional array is obtained. Particularly, in a CT image, the voxel value represents an absorbance of a radiation ray at a position of the voxel in the object, and the voxel value is called a CT value.

The Ray casting method is known as an outstanding technique of volume rendering. The Ray casting method is a technique of applying a virtual ray from a projection plane to an object, and forming an image of a reflected light of the virtual ray from the inside of the object. Thus, an image is formed in which the three-dimensional structure of the inside of the object is seen through on the projection plane.

FIG. 19 shows a volume rendering image of a colon. The volume rendering image is generated by the Ray casting method of volume rendering. The volume rendering image is suitable for observation of a tubular tissue such as the colon from the outside thereof, but not for observation from the inside thereof.

FIG. 20 shows a virtual endoscope image of a colon. The virtual endoscope image is an image showing a view from the virtual endoscope. It is possible to realize a virtual endoscope by generating a perspective projection image using volume rendering, however, it is difficult for a user to observe the inner wall of a tubular tissue such as the colon thoroughly with the virtual endoscope image.

FIGS. 21A and 21B show an MPR (Multi Planar Reconstruction) image. In the MPR image, as an arbitrary cross-sectional plane 202 of a volume 201 is displayed, information concerning the periphery of a tubular tissue such as the colon can also be displayed. However, the shape of the inside of the colon is hard to see.

FIGS. 22A and 22B show a CPR (Curved MPR) image. In the CPR image, as a curved surface can be represented by displaying arbitrary cross-sectional curved planes 211, 212, 213, 214, and 215 of a volume 201, the CPR image is suitable for displaying a winding internal organ such as an intestine. However, the shape of the inside of the intestine is hard to see, similarly as the MPR image.

FIG. 23 shows an exfoliated image of an intestine. In the exfoliated image, assuming a cylindrical coordinate system, etc., virtual rays are radially projected from the center axis of a cylinder, and a 360-degree panoramic image can be obtained. However, in the exfoliated image, a curved portion of the intestine is displayed with distortion, and the positional relationship of the portions of the intestine is hard to understand. Moreover, a polyp in the intestine is stretched out and may be recognized as a fold, or conversely a fold may be recognized as a polyp.

Next, terms with respect to the regions of a tubular tissue will be discussed with reference to FIG. 24. Here, with respect to a tubular tissue 241 such as a colon inside a human body, a region 242 is called “lumen,” a wall surface 243 is called “inner wall surface,” a region 244 is called “inside of wall,” and a region 245 is called “inside and periphery of wall”. Therefore, a portion displayed by the Ray casting in the related art is the “inner wall surface” (generally, a boundary surface), and a portion displayed by the MPR in the related art is the “inside of wall” (substance of volume).

In a related art, for example in JP-A-11-318884, a sectional face cut out along a tubular tissue is set, a CPR image is generated, and then an indicator indicating the position of the cut sectional face on a volume rendering image is displayed with the CPR image side by side.

However, in the image display method in the related art, it is difficult for a user to observe the entire circumference of the inner wall of the tubular tissue, etc., of a human body with an image having no distortion, and observe in detail, a polyp, etc., formed in a fold portion of a curved tubular tissue.

### SUMMARY OF THE INVENTION

An object of the invention is to provide an image display method and a computer readable medium for image display, for enabling a user to observe the entire circumference of the inner wall in a tubular tissue, etc., with an image having no distortion.

An image display method of the invention is an image display method for visualizing a tubular tissue, the image display method comprising: obtaining a path representing a center line of the tubular tissue; setting a mask region of the tubular tissue based on the path; setting at least one dividing plane which follows a direction of the path; obtaining a plurality of divided piece regions by dividing the mask region by the dividing plane; and displaying an image of the tubular tissue by performing three-dimensional image processing on the plurality of the divided piece regions.

According to the configuration, the plurality of divided pieces are obtained by dividing the mask region by the dividing plane which follows the direction of the path representing the center line of the tubular tissue, and the plurality of the divided pieces are displayed as an image at the same time. Accordingly, the image display of the tubular tissue is achieved with an image having no distortion in displaying the whole surrounding of the inner wall surface of the tubular tissue. Thus, a user can observe the entire circumstance of the inner wall in the tubular tissue, etc., with an image having no distortion.

The image display method of the invention further comprises: setting a common reference point with respect to the plurality of divided piece regions; and performing the three-dimensional image processing of the plurality of the divided piece regions based on the reference point. The image display method of the invention further comprises: changing a position of the reference point; and displaying the image of the tubular tissue by performing the three-dimensional image processing based on the changed position of the reference point. In the image display method of the invention, the reference point is positioned on the path representing the center line of the tubular tissue.

The image display method of the invention further comprises: displaying the image of the tubular tissue by further performing two-dimensional image processing on cut surfaces of the plurality of divided piece regions respectively, the cut surfaces made by being cut with the dividing plane. In the image display method of the invention, the two-dimensional image processing is processing of generating a CPR (Curved Planar Reconstruction) image. In the image display method of the invention, the two-dimensional image processing is processing of generating a two-dimensional image based on another data source. In the image display method of the invention, the two-dimensional image processing is processing of generating an MIP (Maximum Intensity Projection) image with a thickness.

Particularly, the two-dimensional image processing in the image display method of the invention indicates generating image information which is represented two-dimensionally and represents the dividing plane. Thus, the two-dimensional image processing includes generating image information which is represented two-dimensionally but uses three-dimensional information, such as typified by a MIP image with thickness as described above. The image information is combined with a volume rendering image or a surface rendering image, and is included in the three-dimensional image displayed by the image display method of the invention.

In the image display method of the invention, the dividing plane is changed dynamically. In the image display method of the invention, the three-dimensional image processing is volume rendering processing. In the image display method of the invention, the three-dimensional image processing is surface rendering processing.

In the image display method of the invention, the three-dimensional image processing is performed by network distributed processing. In the image display method of the invention, the three-dimensional image processing is performed using a GPU (Graphic Processing Unit).

A computer readable medium of the invention is a computer readable medium having a program including instructions for permitting a computer to display an image for visualizing a tubular tissue, the instructions comprising: obtaining a path representing a center line of the tubular tissue; setting a mask region of the tubular tissue based on the path; setting at least one dividing plane which follows a direction of the path; obtaining a plurality of divided piece regions by dividing the mask region by the dividing plane; and displaying an image of the tubular tissue by performing three-dimensional image processing of the plurality of divided piece regions.

### BRIEF DESCRIPTION OF THE DRAWINGS

FIG. 1 is a schematic drawing (1) to describe an image display method of an embodiment of the invention.

FIGS. 2A and 2B are explanatory diagrams of extracting a colon in the image display method of a first embodiment of the invention.

FIG. 3 is an explanatory diagram of setting a dividing plane in the image display method of a first embodiment of the invention.

FIG. 4 is an explanatory diagram of setting a dividing plane in a curved portion of a tubular tissue.

FIG. 5 is an explanatory diagram of rendering divided pieces in the image display method of a first embodiment of the invention.

FIGS. 6A and 6B are explanatory diagrams of geometries when rendering is conducted in the image display method of a first embodiment of the invention.

FIGS. 7A and 7B show display of divided pieces (example 1) in the image display method of a second embodiment of the invention.

FIGS. 8A, 8B, 8C and 8D show display of divided pieces (example 2) in the image display method of a third embodiment of the invention.

FIGS. 9A and 9B show display of divided pieces (example 3) in the image display method of a fourth embodiment of the invention.

FIGS. 10A and 10B are explanatory diagrams of setting dividing planes in the image display method of a fifth embodiment of the invention.

FIGS. 11A, 11B and 11C are explanatory diagrams of CPR overlay on a cut surface in the image display method of a sixth embodiment of the invention.

FIGS. 12A and 12B are schematic drawings (2) to describe the image display method of a sixth embodiment of the invention.

FIGS. 13A, 13B and 13C show display of divided pieces (example 4) in the image display method of a seventh embodiment of the invention.

FIG. 14 is an overall flowchart in the image display method of an embodiment of the invention.

FIG. 15 is a flowchart showing generation of the dividing plane along the path in the image display method of an embodiment of the invention.

FIG. 16A is a flowchart showing generation of the mask region of each divided piece from the dividing plane in the image display method of an embodiment of the invention.

FIG. 16B is an explanatory diagram for the flowchart shown in FIG. 16A.

FIG. 17 is a flowchart to describe the α channel generation of CPR in the image display method of an embodiment of the invention.

FIG. 18 is a flowchart showing synthesis in the image display method of an embodiment of the invention.

FIG. 19 shows a volume rendering image of a colon.

FIG. 20 shows a virtual endoscope image of a colon.

FIGS. 21A and 21B show an MPR (Multi Planar Reconstruction) image.

FIGS. 22A and 22B show a CPR (Curved MPR) image.

FIG. 23 shows an exfoliated image of an intestine.

FIG. 24 is an explanation diagram for terms with respect to regions of a tubular tissue.

### DESCRIPTION OF THE PREFERRED EMBODIMENTS

First, an outline of an image display method according to an embodiment of the invention will be discussed. The image display method according to the embodiment provides a method of visualizing a tubular tissue of a human body, and particularly, an object of the image display method is an observation of the inner wall of the tubular tissue such as a colon with an image having no distortion.

In the image display method of the embodiment, the tubular tissue is extracted as a tubular tissue mask region along a center line (path) of the tube. Then, the extracted tubular tissue mask region is divided with a flat plane or a curved plane (dividing plane) along the center line, and each divided piece is displayed based on volume rendering. In addition, a two-dimensional image (CPR image, etc.,) is applied on each region on each divided piece, the region made by being cut with the dividing plane. Accordingly, a user can see the entire circumstance of the inner wall of the tube with an image having no distortion.

Here, for the tubular tissue mask region, a mask region representing the tubular tissue itself and a mask region representing each divided piece are distinguished from each other. The divided piece represents the divided three-dimensional region respectively (implemented using a mask in the embodiment). A dividing line is a line on a reference plane used to generate the dividing plane, and the reference plane is provided to define the dividing line. A reference point is a base point for projection, and in the embodiment, is an intersection point of the reference plane and the path.

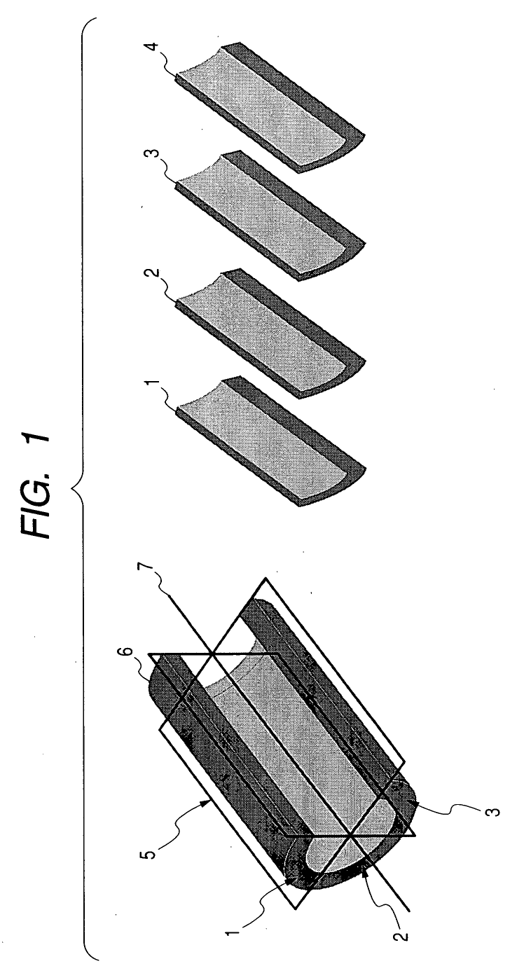

FIG. 1 is a schematic drawing to describe the image display method of the embodiment. A three-dimensional image as a tubular tissue (colon) 6 is divided longitudinally along a center line (path) 7 is generated, and divided pieces 1, 2, 3, and 4 are displayed in association with each other. Accordingly, a user can observe the inner wall surface of the tubular tissue 6 for 360 degrees with an image having no distortion.

According to the image display method of the embodiment, as all divided pieces are displayed, a user can observe the inner wall for 360 degrees. Unlike the exfoliated image, the image does not contain distortion and the positional relationship with respect to the tubular tissue and the divided pieces is also easy to understand. When dividing with two or more dividing planes, a user can simultaneously observe a plurality of dividing planes included in one divided piece.

[First Embodiment]

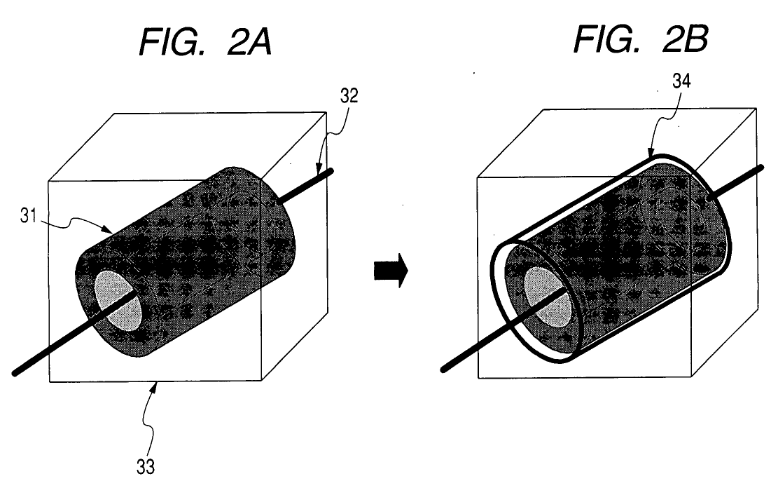

FIGS. 2A and 2B are explanatory diagrams of extracting a colon in the image display method of a first embodiment. First, in volume data 33, the center line of a colon 31 is acquired as a path 32. Next, a mask 34 is set in a region with the path 32 as the center, and a region containing the colon 31 is extracted (tubular tissue mask region).

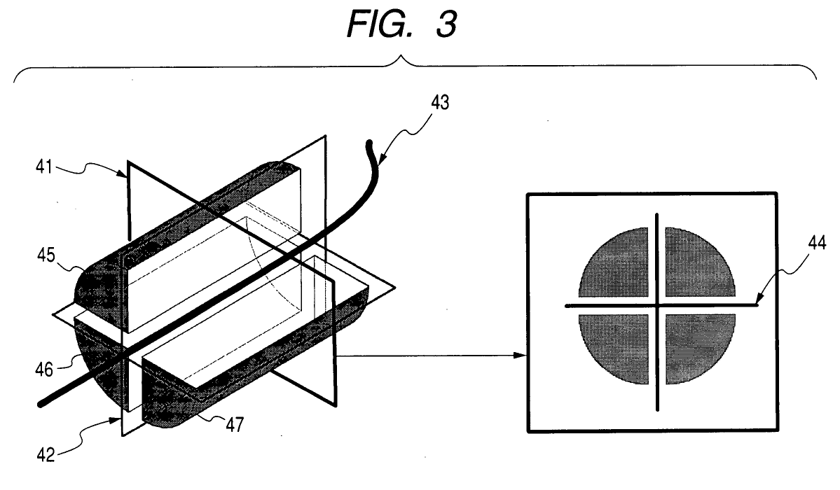

FIG. 3 is an explanatory diagram (1) of setting a dividing plane in the image display method of the first embodiment. At first, a reference plane 41 crossing a path 43 is set, and dividing lines 44 are set on the reference plane 41. The trajectories obtained by moving the dividing lines 44 along the path 43 becomes the dividing planes. A plurality of planes perpendicular to the path 43 are set as dividing planes 42, the tubular tissue mask region is longitudinally divided by the dividing planes 42, and divided mask regions are set as divided pieces 45, 46, and 47, respectively.

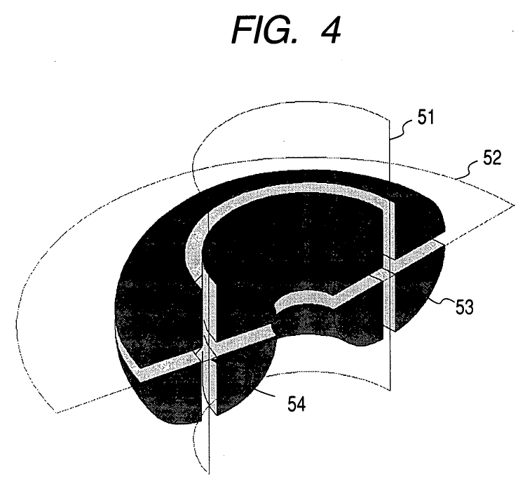

FIG. 4 is an explanatory diagram (2) of setting a dividing plane in a curved portion of a tubular tissue. When a path 54 of a colon 53 is curved, dividing planes 51 and 52 are curved along the path 54.

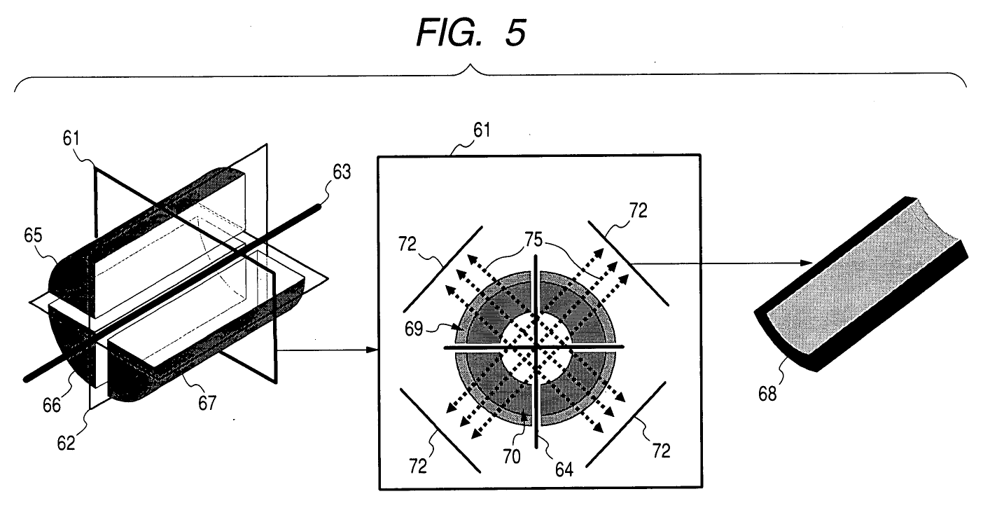

FIG. 5 is an explanatory diagram of rendering divided pieces in the image display method of the first embodiment. Divided pieces 65, 66, 67, and 68 are respectively rendered. Projection directions 75 of virtual rays and offset positions are adjusted so as to provide an image in which each of the divided pieces 65, 66, 67, and 68 of a colon 70 are viewed from the inside of the colon 70. (In FIG.5, a reference plane 61, a dividing plane 62, a path 63, a dividing line 64, a mask 69 and projection planes 72 are shown.)

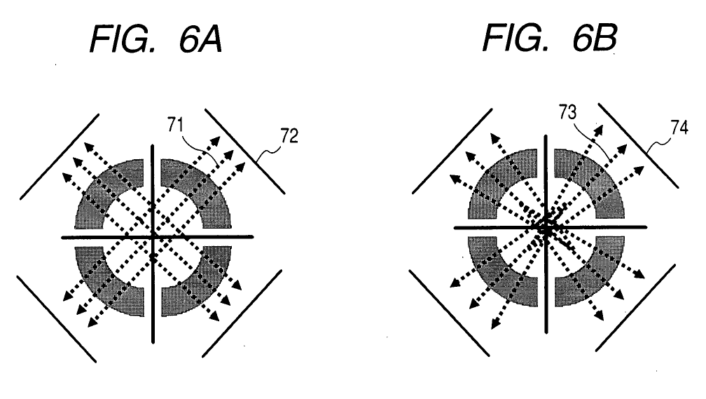

FIGS. 6A and 6B are explanatory diagrams of geometries when rendering is conducted in the image display method of the first embodiment. The projection directions and the offset positions of virtual rays 71, 73 used to render each of the divided pieces are made common based on a common reference point. For example, in parallel projection shown in FIG. 6A, the virtual ray 71 is projected on the reference plane at angles directing to the divided pieces. The virtual ray 71 passing through the reference point is used as the offset reference of the image. Offsets of other virtual rays are determined based on the offset reference.

In this case, the reference plane may be a curved plane. For example, when the reference plane is a cone with the reference point as vertex, an image is provided in which the divided piece is viewed obliquely. This description applies to the parallel projection method, however, maybe also applied to perspective projection shown in FIG. 6B. In FIGS. 6A and 6B, projection planes 72, 74 are shown.

[Second Embodiment]

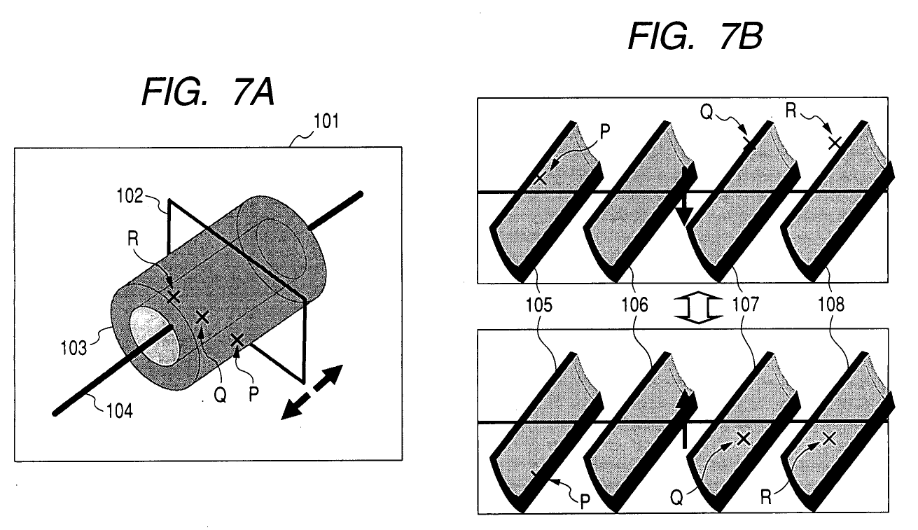

FIGS. 7A and 7B show display of divided pieces (example 1) in the image display method of a second embodiment. In this example, a reference plane 102 is moved along a path 104. The reference plane 102 is displayed on a three-dimensional image 101 before a colon 103 is divided for display, and the position of the reference plane 102 can be moved with a mouse. When the reference plane 102 moves, images of divided pieces 105, 106, 107, and 108 are also scrolled in conjunction with the reference plane 102.

According to the embodiment, a region of interest on the inner wall of the tubular tissue is divided by the dividing plane along the path which represents the center line of the tubular tissue. As for the inside and the periphery of the wall on the dividing plane, cross-sectional image of the inside and the periphery of the wall is displayed and the image of the region of interest can be scrolled by mouse operation. Accordingly, a user can observe the entire circumstance of the inner wall of the tubular tissue with an image having no distortion.

[Third Embodiment]

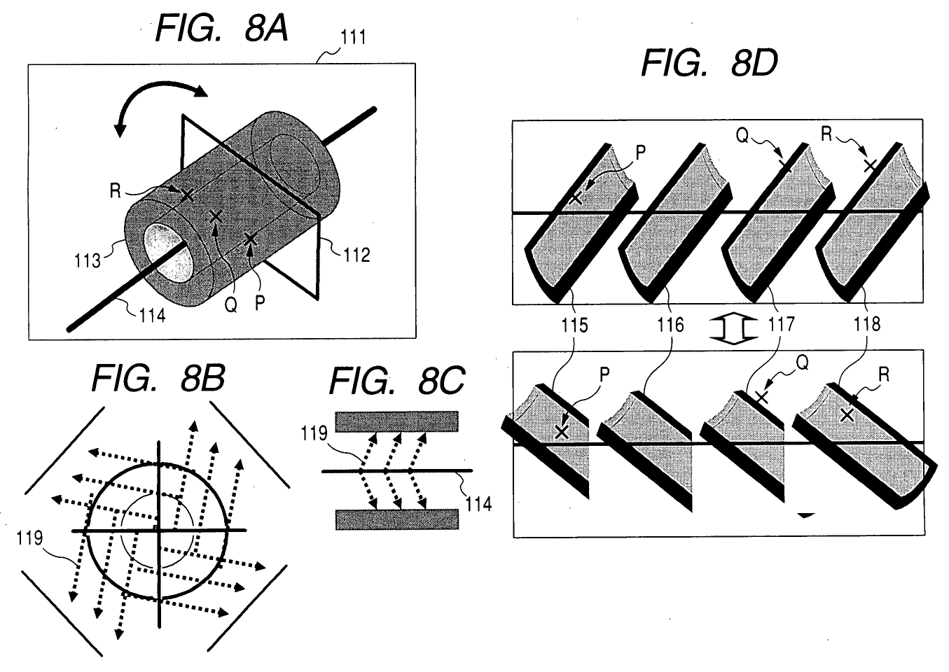

FIGS. 8A, 8B, 8C and 8D show display of divided pieces (example 2) in the image display method of a third embodiment. In this example, projection angles are changed in a coordinated manner. When the projection angles are changed in a coordinated manner, images of all divided pieces 115, 116, 117, and 118 are changed in orientation or are rotated so as to view a colon 113 from a different angle. (In FIGS. 8A, 8B and 8C, a three-dimensional image 111, a reference plane 112, a path 114 and a virtual ray 119 are shown.)

According to the embodiment, divided pieces of region of interest of the tubular tissue are all displayed, so that a user can observe the inner wall without distortion over 360 degrees, and each of the images of the divided pieces are changed in orientation in conjunction with the change of the projection angle. Accordingly, a user can precisely understand the positional relationship of a plurality of the dividing planes.

[Fourth Embodiment]

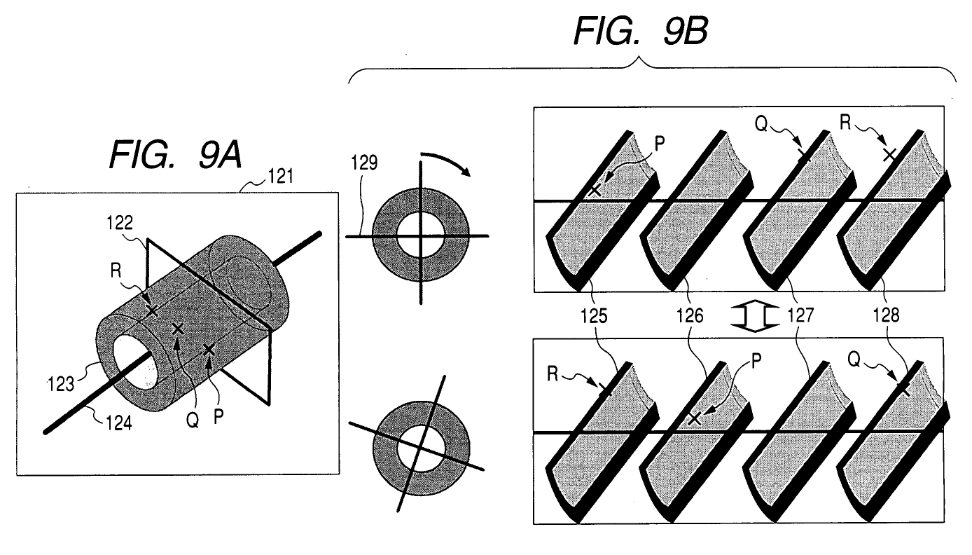

FIGS. 9A and 9B show display of divided pieces (example 3) in the image display method of a fourth embodiment. In this example, a dividing plane 129 is moved. When the angle of a reference plane 122 is changed, images of all divided pieces 125, 126, 127, and 128 are changed in orientation or are rotated so as to view a colon 123 from a different angle. (In FIG.9A, a three-dimensional image 121 and a path 124 are shown.)

According to the embodiment, as the dividing plane moves, the method is suitable for a user to observe the inside of the wall of the intestine on the dividing plane thoroughly.

[Fifth Embodiment]

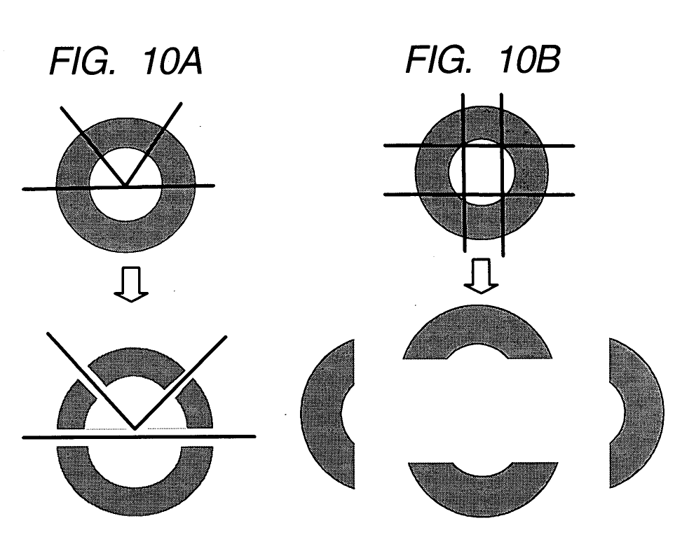

FIGS. 10A and 10B are explanatory diagrams of setting dividing planes in the image display method of a fifth embodiment. The dividing planes can be set as desired on the screen, and need not be set at equal angles. The dividing planes need not pass through the center path., Moreover, divided pieces may overlap in some regions (overlap region may exist in volume data).

Thus, in the embodiment, dividing planes can be set as desired on the screen, and number of divisions can be selected in response to the degree of curves of the tubular tissue. Accordingly, an appropriate diagnosis image can be displayed in response to the shape of the region of interest.

[Sixth Embodiment]

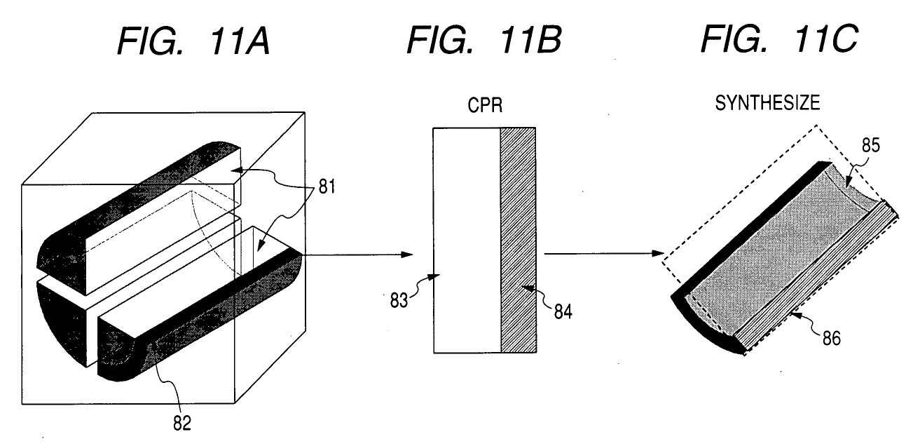

FIGS. 11A, 11B and 11C are explanatory diagrams of CPR overlay on a cut surface in the image display method of a sixth embodiment. A CPR (Curved Planar Reconstruction) image is applied on a surface 81 of a cut mask region. The CPR image is a cross-sectional curved plane of an original volume. Transparency is set on the CPR image, and a volume rendering image of a divided piece is seen through the transparent region. Accordingly, a user can observe the inside of the wall and the inner wall surface at the same time. (In FIGS. 11A, 11B and 11C, a colon 82, air 83 which is transparent, inside and periphery of wall 84 which are opaque, an inner wall surface 85 and inside and periphery of wall 86 are shown.)

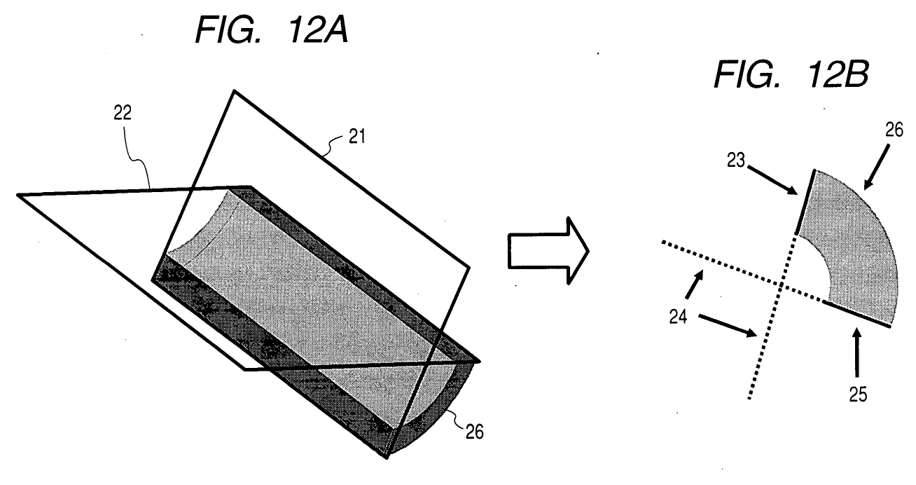

In this case, when the number of dividing planes is one, the dividing plane and the divided piece may be simply synthesized. However, when the number of dividing planes is two or more, one dividing plane is covered and hidden by another dividing plane. Thus, as shown in FIGS. 12A and 12B, dividing planes 21 and 22 corresponding to each divided piece 26 are generated (step 1), and portions of each of the dividing planes 21, 22 not touching the divided piece 26 are deleted (step 2). Thus, display region of the dividing planes 21, 22 is set for each divided piece 26. (In FIG. 12B, portions of dividing plane to be displayed 23,25 and portions of dividing plane not to be displayed 24 are shown.)

According to the embodiment, only the portion of each dividing plane touching the divided piece is obtained at step 2. Therefore, a plurality of CPR images can be applied considering the positional relationship (back and front), while only one CPR image can be applied in the related art. At step 2, the portions of each of the dividing planes not touching the divided piece may be made transparent and not displayed based on an α channel (described later), instead of being deleted.

[Seventh Embodiment]

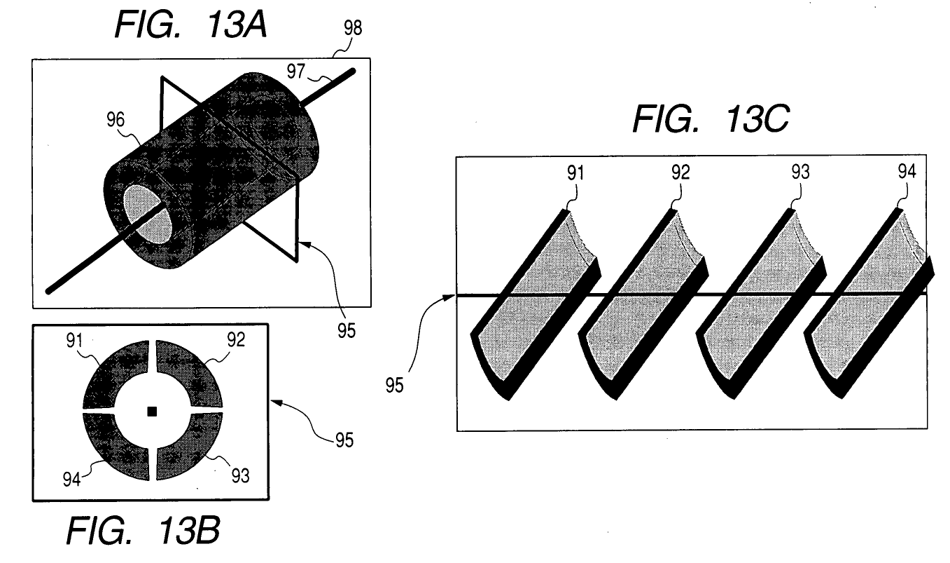

FIGS. 13A, 13B and 13C show display of divided pieces (example 4) in the image display method of a seventh embodiment. Divided pieces 91, 92, 93, and 94 are displayed in association with each other. Using a reference plane 95, the divided pieces 91, 92, 93, and 94 are put in order for display. For example, the positional relationship of the divided pieces 91, 92, 93, and 94 is displayed on a three-dimensional image 98 before a colon 96 is divided for display and on the reference plane 95. (In FIG. 13A, a path 97 is shown.)

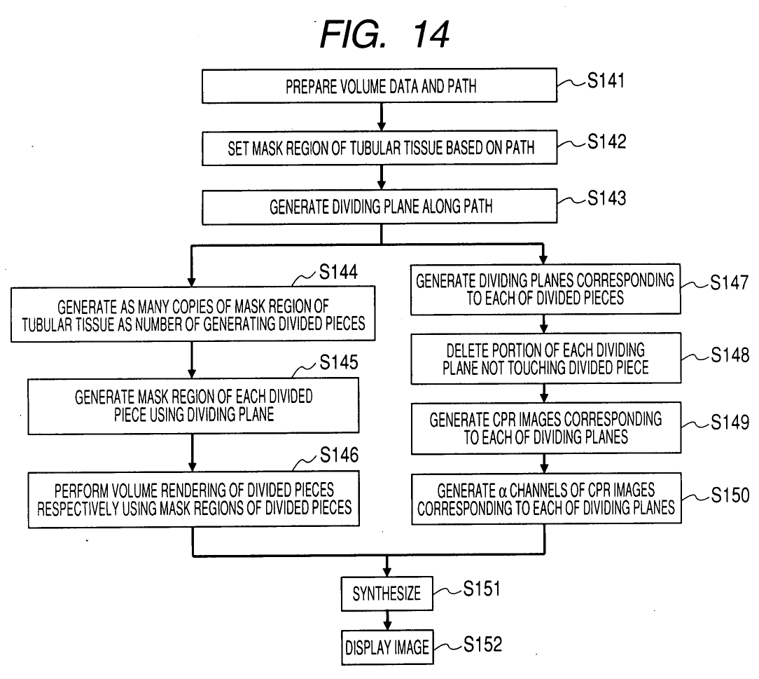

FIG. 14 is an overall flowchart in the image display method of an embodiment. To begin with, volume data and a path are prepared (step S141). Next, a mask region of the tubular tissue is set using the path (step S142), and a dividing plane along the path is generated (step S143).

Next, as many copies of the mask region of the tubular tissue as a number of generating divided pieces are generated (step S144), and the mask region of each divided piece is generated using the dividing plane based on the copies of the mask region of the tubular tissue (step S145). Then, volume rendering of the divided pieces is performed respectively, using the mask regions of the divided pieces (step S146).

On the other hand, at the same time as step S144 is executed, dividing planes corresponding to each of the divided pieces are generated (step S147). In other words, dividing planes corresponding to each of the divided pieces are set. Then, a portion of each dividing plane not touching the divided piece is deleted (step S148). Step S148 is important when images corresponding to a plurality of dividing planes are displayed at the same time by deleting the portion not touching the divided pieces. Next, CPR images corresponding to each of the dividing planes are generated (step S149), and α channels of the CPR images corresponding to the dividing planes are generated (step S150).

The volume rendering image of the divided pieces generated at step S146 and the α channels of the CPR images corresponding to the dividing planes generated at step S150 are synthesized (step S151), and the synthesized image is displayed (step S152).

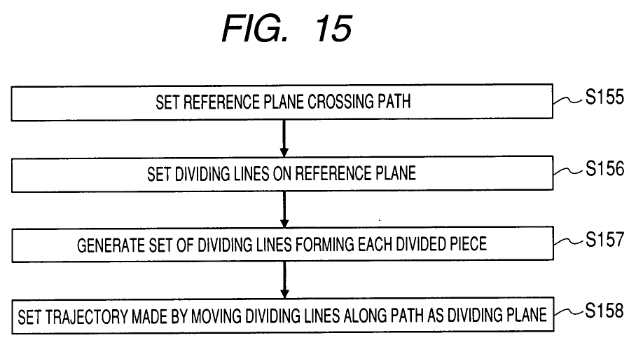

FIG. 15 is a flowchart showing generation of the dividing plane along the path (S143) in the image display method of the embodiment. First, a reference plane crossing the path is set (step S155). Next, dividing lines are set on the reference plane (step S156). Next, a set of the dividing lines forming each divided piece is generated (step S157). Then, a trajectory made by moving the dividing lines along the path is set as a dividing plane (step S158).

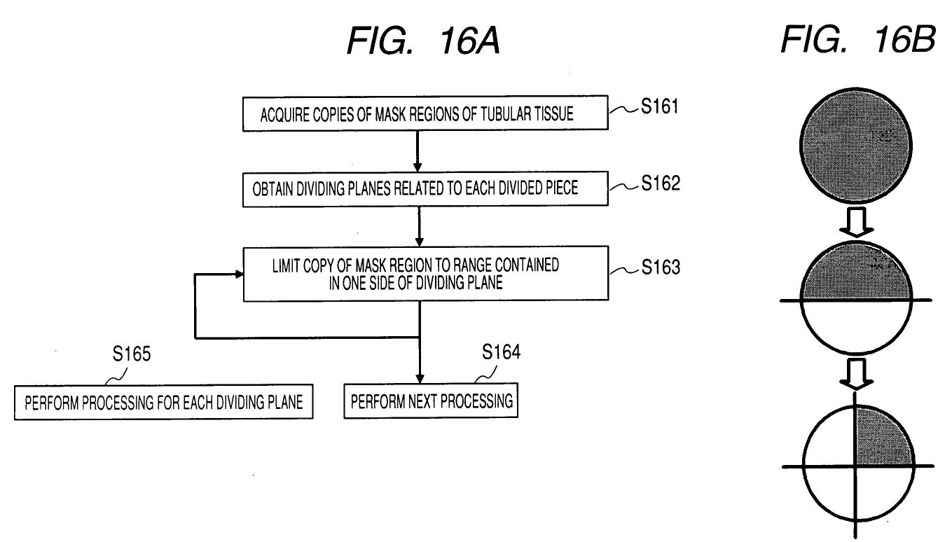

FIG. 16A is a flowchart showing generation of the mask region of each divided piece from the dividing plane (S145) in the image display method of the embodiment. FIG. 16B is an explanatory diagram for the flowchart shown in FIG. 16A. First, copies of the mask regions of the tubular tissue are acquired (step S161). Next, dividing planes relating to each divided piece are obtained (step S162). Next, the copy of the mask region is limited to a range contained in one side of the dividing plane (step S163). Then, next processing is performed (step S164). The above-described processing is performed for each dividing plane (step S165).

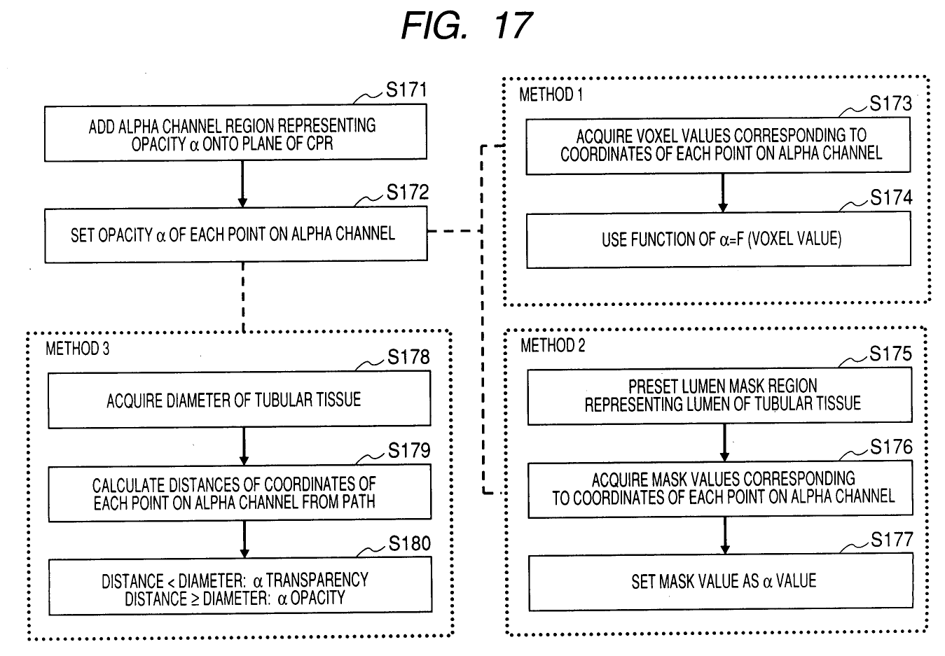

FIG. 17 is a flowchart to describe the α channel generation of CPR in the image display method of the embodiment. First, an alpha channel region representing opacity α is added onto the plane of CPR (step S171). Next, opacity α of each point on the alpha channel is set (step S172). In doing so, when a plurality of CPR images corresponding to one divided piece exists, a positional relationship (back and front) of the plurality of CPR images and the divided piece can be shown appropriately.

In method 1, the voxel value corresponding to the coordinates of each point on the alpha channel is acquired (step S173). Next, a function of α=f (voxel value) is used (step S174).

In method 2, a lumen mask region representing a lumen of the tubular tissue is preset (step S175), and the mask value corresponding to the coordinates of each point on the alpha channel is acquired (step S176). The mask value is set as α value (step S177).

In method 3, a diameter of the tubular tissue is acquired (step S178), and distance of the coordinates of each point on the alpha channel from the path are calculated (step S179). Then, if distance<diameter, an α value representing transparency is set; if distance≧diameter, an α value representing opacity is set (step S180).

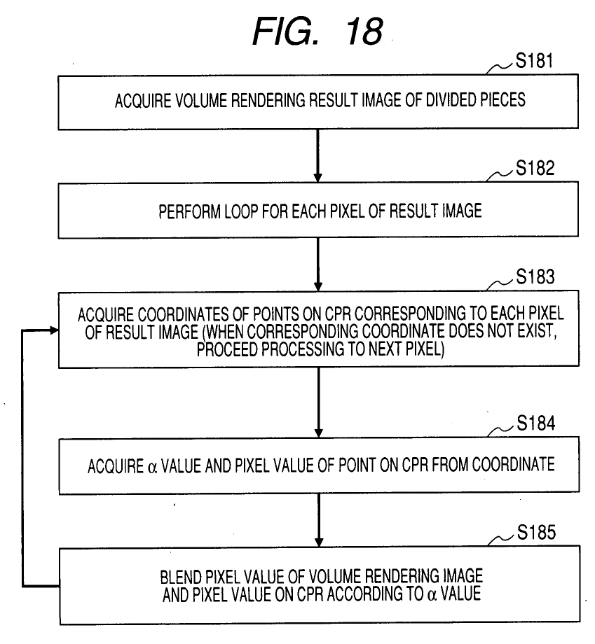

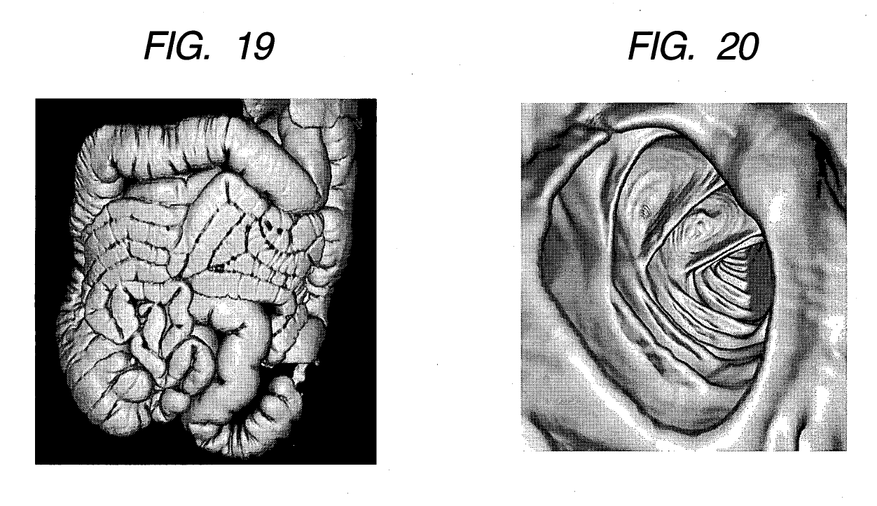

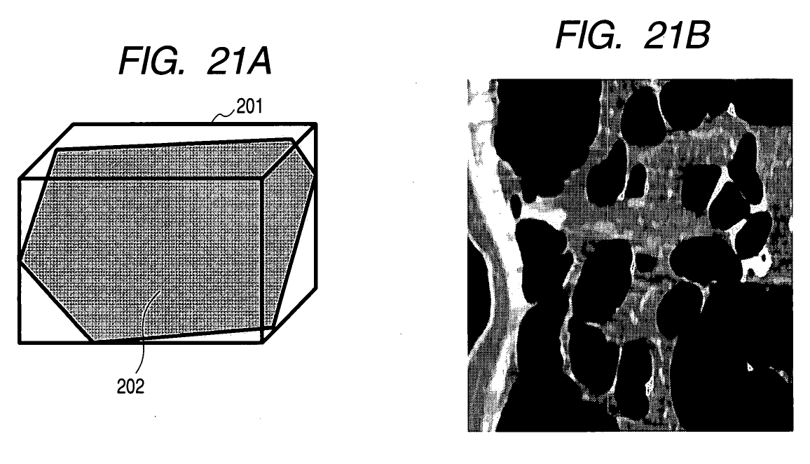

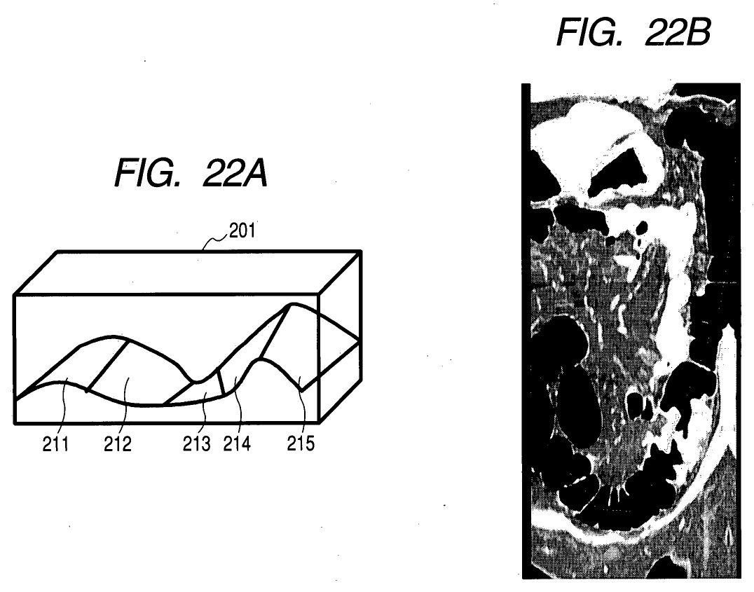

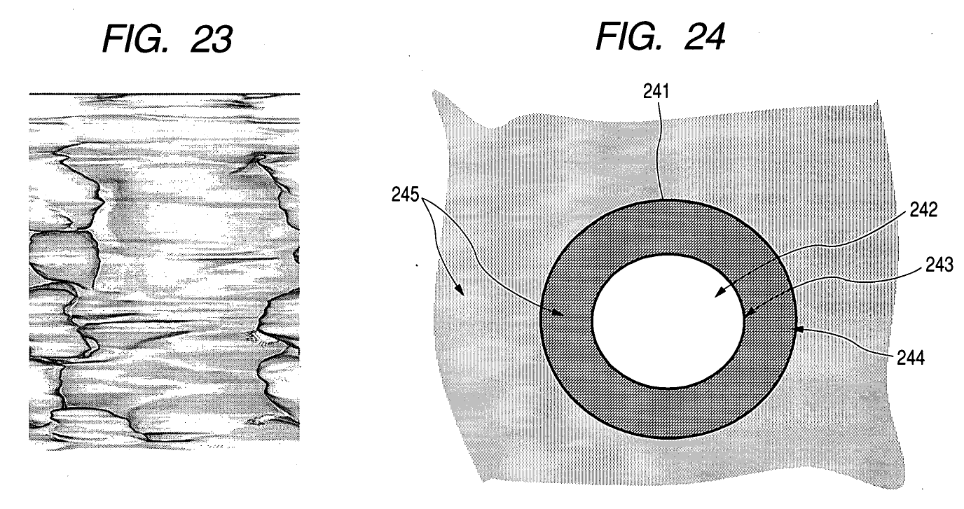

FIG. 18 is a flowchart showing synthesis in the image display method of the embodiment. First, a volume rendering result image of the divided pieces is acquired (step S181). Next, a loop for each pixel of the result image is performed (step S182).

In this loop, the coordinates of the points on CPR corresponding to each pixel of the result image are acquired (when the corresponding coordinate does not exist, the processing is proceeded to the next pixel) (step S183). Next, the α value and the pixel value of the point on CPR are acquired from the coordinate (step S184). The pixel value of the volume rendering image and the pixel value on CPR are blended according to the α value (step S185).

Thus, according to the image display method of the embodiment, image display of the tubular tissue is executed by performing three-dimensional image processing of a plurality of divided piece regions which are obtained by dividing the tubular tissue by the dividing plane along the path representing the center line of the tubular tissue. Accordingly, an image having no distortion with respect to the divided piece regions can be generated, so that a user can observe the observation object over a wide range without overlooking, and can easily find a small polyp, infiltration, etc., existing in the inside of the wall and on the inner wall surface of the tubular tissue.

In the description of the image display method of the embodiment, images photographed by the parallel projection method are mainly shown by way of example. However, the image display method can also be applied similarly to images provided by various projection methods such as cylindrical projection method and perspective projection. In the description of the embodiment, the CPR image of the CT apparatus is superposed on the volume rendering image of the CT apparatus by way of example. However, images provided by different types of medical image apparatuses can be used, such as that the CPR image of MRI, PET (Positron-Emission Tomography), or ultrasonic diagnostic apparatus is superposed on the volume rendering image of MRI, and that an image obtained by combining some of the CPR images of MRI, PET, and ultrasonic diagnostic apparatus is superposed on the volume rendering image of MRI. Moreover, a plurality of images obtained from the same medical image apparatus may be combined.

In the image display method of the embodiment, the images at the same position are superposed. However, images can be superposed by shifting position, angle, or magnifying scale power according to an operation of a user or calculation. Accordingly, alignment of the images obtained from different types of apparatuses can be performed, and a portion that cannot directly be observed can be visualized.

In the description of the embodiment, the inner wall surface and the inside of the wall are shown by way of example. However, in the image display method, not only surfaces such as the outer wall surface and the inside of the wall but also the peripheral portions, such as a face representing some boundary and a cross section obtained by cutting out the substance of the inside of a volume, may respectively be displayed.

In the embodiment, volume rendering is used to display the inner wall surface and the inside of the wall. However, either or both of the inner wall surface and the inside of the wall can also be calculated by surface rendering. Surface rendering is a displaying method of a three-dimensional image using a plane element such as a polygon, for example. In this case, the plane element can be obtained from an inner wall surface or a cut cross section.

Calculation processing for superposing a CPR image on a volume rendering image can be performed by a GPU (Graphic Processing Unit). GPU is a processing unit designed to be specialized in image processing as compared with a general-purpose CPU, and usually is installed in a computer separately from the CPU.

In the image display method of the embodiment, three-dimensional image processing and two-dimensional image processing maybe performed by network distributed processing. Volume rendering calculation can be divided at a certain angle unit, image region, volume region, etc., and the divided calculation can be superposed later. Therefore, the volume rendering calculation can be performed by parallel processing, network distributed processing, a dedicated processor, or using them in combination.

The image processing method of the embodiment can also be applied to MIP (Maximum Intensity Projection), which is a method of performing image processing by acquiring the maximum value of the voxels on a projected virtual ray. MIP can be executed by comparatively easy calculation in volume rendering methods, and methods of acquiring the minimum value, the average value, and the addition value of the voxels on a projected virtual ray are available as similar processing. Particularly, the method of acquiring the minimum value is called MINIP (Minimum Intensity Projection). Further, the image processing method of the embodiment can also be applied to MIP with thickness or MINIP with thickness, in which a cross section like MPR is cut out with some thickness and then MIP processing or MINIP processing is respectively performed on the cross section having thickness.

In the embodiment, CPR is illustrated as an image representing the inside of the tissue, but the image is not limited to CPR and may be an arbitrary curved plane corresponding to the shape of the cut cross section.

In the embodiment, to set a numeric value in determining a cut cross section, the numeric value can be determined by a program or can be specified by a user. Particularly, a user can dynamically change the numeric value using GUI such as a mouse drag, a slider bar and a keyboard. In addition, animation display by changing the numeric value continuously is also possible.

According to the invention, the image display of the tubular tissue can be performed by displaying a plurality of divided pieces at the same time, by dividing with the dividing plane along the path representing the center line of the tubular tissue. Accordingly, the whole circumstance of the inner wall surface of the tubular tissue can be displayed in an image having no distortion, enabling a user to observe the entire circumstance of the inner wall in the tubular tissue, etc., with an image having no distortion.

It will be apparent to those skilled in the art that various modifications and variations can be made to the described preferred embodiments of the present invention without departing from the spirit or scope of the invention. Thus, it is intended that the present invention cover all modifications and variations of this invention consistent with the scope of the appended claims and their equivalents.

What is claimed is:

1. An image display method for visualizing a tubular tissue, said image display method comprising:
obtaining a path representing a center line of the tubular tissue;
setting a mask region of the tubular tissue based on the path;
setting at least one dividing plane which follows a direction of the path;
obtaining a plurality of divided piece regions by dividing the mask region by the dividing plane; and
displaying an image of the tubular tissue by performing three-dimensional image processing on the plurality of the divided piece regions.

2. The image display method as claimed in claim 1, further comprising:
setting a common reference point with respect to the plurality of the divided piece regions; and
performing said three-dimensional image processing of the plurality of the divided piece regions based on said reference point.

3. The image display method as claimed in claim 2, further comprising:
changing a position of said reference point; and
displaying the image of the tubular tissue by performing said three-dimensional image processing based on said changed position of the reference point.

4. The image display method as claimed in claim 2, wherein said reference point is positioned on the path.

5. The image display method as claimed in claim 1, further comprising:
displaying the image of the tubular tissue by further performing two-dimensional image processing on cut surfaces of said plurality of the divided piece regions respectively, said cut surfaces made by being cut with the dividing plane.

6. The image display method as claimed in claim 5, wherein said two-dimensional image processing is processing of generating a CPR (Curved Planar Reconstruction) image.

7. The image display method as claimed in claim 5, wherein said two-dimensional image processing is processing of generating a two-dimensional image based on another data source.

8. The image display method as claimed in claim 5, wherein said two-dimensional image processing is processing of generating an MIP (Maximum Intensity Projection) image with a thickness.

9. The image display method as claimed in claim 1, wherein said dividing plane is changed dynamically.

10. The image display method as claimed in claim 1, wherein said three-dimensional image processing is volume rendering processing.

11. The image display method as claimed in claim 1, wherein said three-dimensional image processing is surface rendering processing.

12. The image display method as claimed in claim 1, wherein said three-dimensional image processing is performed by network distributed processing.

13. The image display method as claimed in claim 1, wherein said three-dimensional image processing is performed using a GPU (Graphic Processing Unit).

14. A computer readable medium having a program including instructions for permitting a computer to display an image for visualizing a tubular tissue, said instructions comprising:
obtaining a path representing a center line of the tubular tissue;
setting a mask region of the tubular tissue based on the path;
setting at least one dividing plane which follows a direction of the path;
obtaining a plurality of divided piece regions by dividing the mask region by the dividing plane; and
displaying an image of the tubular tissue by performing three-dimensional image processing of the plurality of the divided piece regions.

15. The computer readable medium as claimed in claim 14, said instructions further comprising:
displaying the image of the tubular tissue by further performing two-dimensional image processing on cut surfaces of said plurality of the divided piece regions respectively, said cut surfaces made by being cut with the dividing plane.
